(19) United States
(12) Patent Application Publication
(10) Pub. No.: US 2009/0222315 A1
(43) Pub. Date: Sep. 3, 2009

(54) SELECTION OF TARGETED ADVERTISEMENTS

(75) Inventor: RAYMOND FRANCIS HAYES, JR., Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/039,429

(22) Filed: Feb. 28, 2008

(51) Int. Cl. G06Q 30/00

(52) U.S. Cl. 705/10; 705/14

(57) ABSTRACT

System, methods, and computer-storage media are provided for selecting advertisements specifically targeted to a first end user. Information is provided by a second end user that describes characteristics and interests of the first end user. The information provided by the second user is used to select advertisements specifically targeted to the first end user. The selected advertisements are presented to the first end user through computer-enabled forms of communication between the first end user and the second end user.

### BACKGROUND

Advertisements are routinely presented to end users in computing environments. The targeting of advertisements to end users based on information describing the end users is often preferred in order to increase the likelihood that an end user will purchase the goods or services promoted by the advertisement. A number of approaches have been employed to gather information in an attempt to properly target advertisements to end users. For instance, the gathering of information to aid in the selection of targeted advertisements to present to a particular end user may be performed by analyzing the websites that the end user has visited in the past. Other approaches involve gathering information for targeting advertisements by tracking the searches executed by a user, tracking purchase information, tracking a user's location, as well as a wide variety of other methods. Despite these methods, end users are routinely presented with advertisements for goods or services that they have no interest in purchasing. Advertisers expend vast sums blanketing the market with their advertisements and more often than not reach end users having little interest in purchasing the goods or service promoted by the advertisements.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to selecting advertisements that are specifically targeted to a first end user and presenting the selected advertisements. The task of selecting advertisements that are specifically targeted to a first end user is accomplished by analyzing information describing the first end user, as provided by a second end user. The information provided by the second end user may be varied in nature, but in general it may describe the first user in such a way as to provide characteristics that indicate particular products or services that may interest the first end user. Advertisements are therefore selected for presentation to the first end user that are specifically tailored to the first end user based on the first end user's characteristics and/or interests. In one embodiment, the information provided by a second end user describing a first end user may include one of the following: activities, hobbies, interests, relationship status, education background, affiliation with the second end user, or any other information that would facilitate selecting an advertisement targeted to the first end user.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a system diagram depicting an exemplary system for selecting and presenting advertisements according to one embodiment of the present invention;

FIG. 3 is a block diagram depicting the selection and presentation of advertisements according to one embodiment of the present invention;

FIG. 4 is a block diagram depicting the selection and presentation of advertisements in accordance with another embodiment of the present invention;

FIG. 5 is a block diagram depicting the selection and presentation of advertisements in accordance with a further embodiment of the present invention;

FIG. 6 is a flow diagram showing a method of selecting and presenting targeted advertisements according to an embodiment of the present invention;

FIG. 7 is a flow diagram showing a method of presenting targeted advertisements to an end user in accordance with an embodiment of the present invention;

FIG. 8 is a flow diagram showing a method of selecting a targeted advertisement in response to a request for content at a web server according to an embodiment of the present invention; and

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless, and except, when the order of individual steps is explicitly described. Figures below will use like numbers when possible in order to show similarities and differences from figure to figure.

Embodiments of the present invention are directed to, among other things, selecting targeted advertisements to present to a first end user based on information provided a second end user. The information provided by the second end user may take many forms, but generally it is information, such as biographical and socioeconomic information, that describes characteristics and interests of the first end user in sufficient detail as to allow the efficient selection of advertisements to present to the first end user. The advertisements are specifically tailored based on the information provided by the second end user. For instance, the second end user may provide information to an advertisement server that indicates the first end user resides in one city and regularly travels to a particular city in a foreign country. The advertisement server could then select advertisements for plane tickets from the first end user's city of residence to the city in a foreign country. This selected advertisement is then presented to the first end user by utilizing various methods.

In some embodiments, the second end user may be motivated to provide this information about the first end user through a process similar to what is known in that art as affiliate marketing. Those skilled in the art understand affiliate marketing to generally encompass a method where web sites direct web traffic to a retailer's website in return for monetary compensation. A common example involves a banner advertisement displayed on a third party website. For every user that clicks on the banner advertisement, the operator of the third party website is compensated by the purveyor of the goods or services promoted by the advertisement. The second end user would be in a position analogous to that of the operator of the third party website in the above-described affiliate marketing model. Whenever the first end user clicks on an advertisement provided to the first end user based on the information supplied by the second end user, the second end user will be compensated. The compensation could be monetary in nature, or could take other forms in different embodiments of the invention.

Embodiments of the present invention use computer-enabled communication between the first end user and the second end user to present the selected advertisements to the first end user. The advertisements may be presented before the users engage in computer-enabled communication, during the communication, or after the communication has concluded. In some embodiments, advertisements selected for the first end user may be communicated during a direct communication between the first and second end users, such as real time network based messaging (instant messaging), email, etc. In some cases, the advertisements may first be cached at a user device associated with the second user, and then transferred to a user device associated with the first user for presentation to the first end user. In other cases, the advertisements may be retrieved from the advertisement server or associated device during a communication between the first and second end users. In other embodiments, the advertisement may be presented in response to a request for content from a web server. For instance, the request for content may be a request to view a web page or profile created by the second end user on a social networking website or other similar type website. The advertisement is then presented in conjunction with the profile of the second end user.

Having briefly described an overview of embodiments of the present invention, an exemplary operating environment suitable for implementing embodiments hereof is described below.

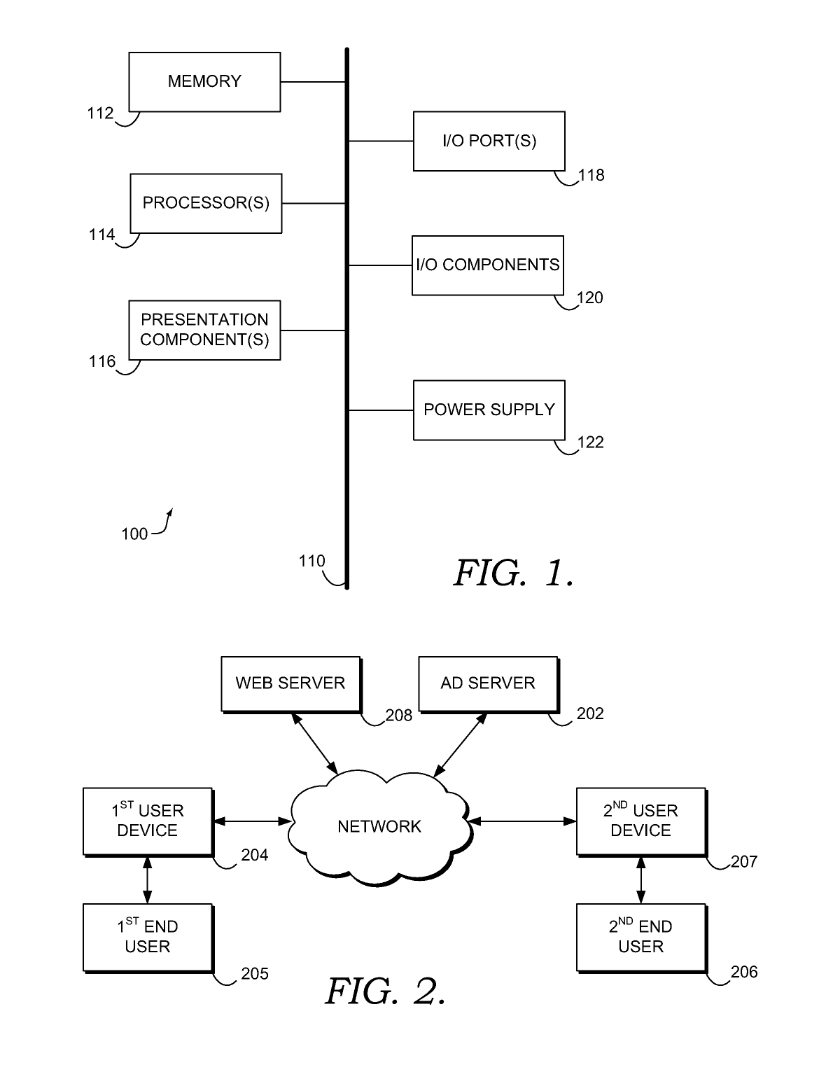

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/modules illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventor recognizes that such is the nature of the art, and reiterates that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

Turning now to FIG. 2, a block diagram is provided that illustrates an exemplary system for selection and presentation of advertisements according to one embodiment of the present invention. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system may include an advertisement server 202, a first user device 205, and a second user device 207. Each of the components shown in FIG. 2 may be any type of computing device, such as computing device 100 described with reference to FIG. 1, for example. The advertisement server 202 is communicatively coupled to the network 201. The second user device 207 and the first user device are also communicatively coupled to the network 201. The first user device 205 and the second user device 207 may communicate and transfer data and information to each other, as well as the advertisement server 202, through the network 201. One skilled in the art will recognize that there are a variety of communication methods that may encompass network 201, including but not limited to: the internet, analog telecommunications network, private data networks, and cellular type networks. Common to all of these networks is their ability to facilitate the transmission of data and information between the first user device 205, the second user device 207, and the advertisement server 202. It should be understood that any number of user devices and advertisements servers may be employed within the system within the scope of the present invention. Additionally, other components not shown may also be included within the system.

The first end user 204 and second end user 206 are also depicted in FIG. 2. The first end user 204 and the second end user 206 are regular human users in the ordinary understanding of the term in one embodiment of the invention. The first end user 204 and the second end user 206 are able to input information into the second user device 207 and first user device 205, respectively. They are also able to receive outputted information from the first user device 205 and the second user device 207, respectively. In some embodiments, the first user device 205 and second user device 207 may be one of the following: a personal computer, a handheld computer, a personal digital assistant (PDA), a cellular telephone, or any other device that would permit input and output of information with a human user.

In some embodiments of the present invention, the advertisement server 202 may be one or more servers that select advertisements to present to end users. The advertisement server 202 utilizes information provided by a second end user 206 that describes traits and/or characteristics of a first end user 204 to select advertisements that are specifically targeted to the first end user 204. In this embodiment, specifically targeted advertisements are advertisements for goods and/or services that would be of particular interest to first end user 204 based on the information provided by a second end user 206.

In some embodiments, the second end user 206 employs a user device 207 to provide information about a first end user 204 to the advertisement server 202. The advertisement server 202 then selects a targeted advertisement to present to the first user 204. In some embodiments, advertisements are transferred to the user device 205 of the second end user 206 for caching after they are selected by the advertisement server 202. The targeted advertisements are then transferred from the user device 207 of the second end user 206 to the user device 205 of the first end user 204 when the first end user 204 and second end user 206 engage in a form of computer-enabled communication. In other embodiments, the advertisements are not cached at the user device 207 of the second user 206. Instead, the advertisements are transferred from the advertisement server 202 to the user device 205 of the first end user 204 when the first end user 204 and second end user 206 engage in a form of computer-enabled communication. In yet other embodiments, the targeted advertisements are presented to a first end user 204 when they request content from a web server 208. The targeted advertisements may be selected in the same method as the other embodiments, but are instead presented in conjunction with a request for content from a web server 208 by a first end user 204.

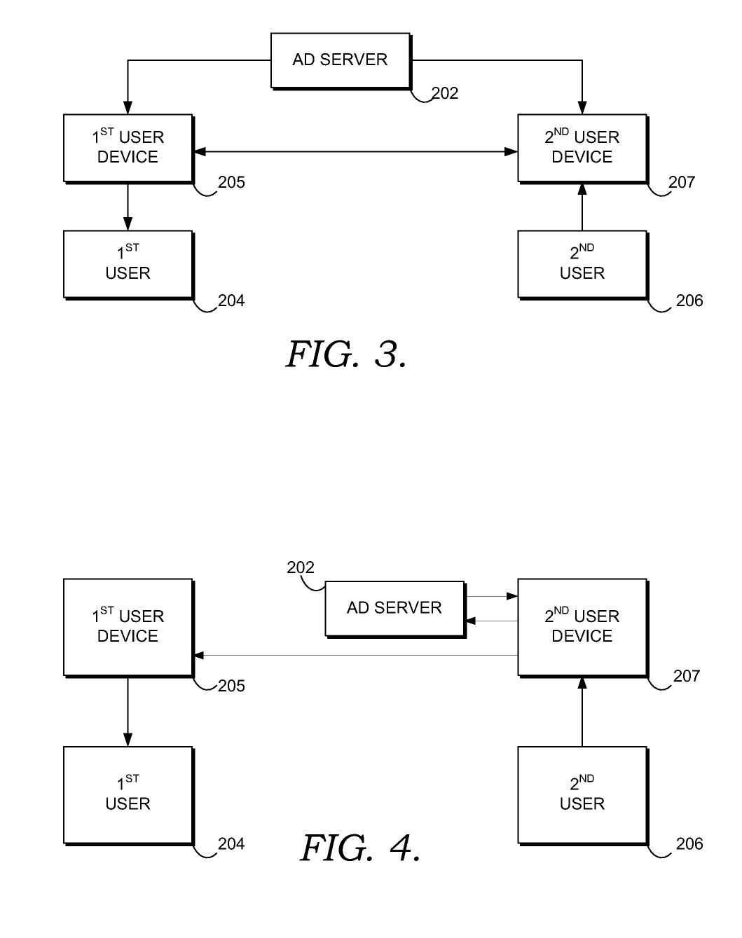

FIGS. 3, 4, and 5 are presented to depict the flow of information between the various components of the system and the first end user 204 and the second end user 206 in some embodiments of the invention. A second end user 206 employs a user device 207 to provide information to an advertisement server 202 that generally describes characteristics of a first end user 204. The advertisement server 202 uses this information to selected advertisements that are specifically targeted to the first end user 204. Different embodiments of the invention utilize varying methods to present the targeted advertisements to the first end user 204. One embodiment caches the advertisements at the user device 207 of the second end user 206, and then transfers them to the user device 205 of the first end user 204 when the users engage in a computer-enabled form of communication. The advertisements are then presented to the first end user 204 by their user device 205. In other embodiments, the information is provided by a second end user 206 to an advertisement server 202 and the targeted advertisements are selected in a similar manner, however advertisements are communicated from the advertisement server 202 to the user device 205 of the first end user 204, and presented to the first end user 204 when engaged in a computer-enabled form of communication with the second end user 206. Other embodiments present selected the advertisements in a similar manner, but the advertisements are presented to the first end user 204 when they request content from a web server 208.

Turning now to FIG. 3, the flow of information and data relating to selection and presentation of advertisements is depicted, according to one embodiment of the invention. In this embodiment, the second end user 206 inputs information describing the first end user 204 into the second user device 207. The information describing the first end user 204 is then transferred to the advertisement server 202. The advertisement server 202 then selects an advertisement based on the information provided by the second end user 206. The process strives to select advertisements that would be of special interest to the first end user 204. For instance, if the information supplied by the second end user 206 indicates that the first end user 204 builds model airplanes as a hobby, the advertisement server 202 may select advertisements for model airplanes to present to the first end user 204. If the information provided by the second end user 206 indicated that the first end user 204 was not married, the advertisement server 202 may select advertisements for dating services to present to the first end user 204. In another example, the information provided by the second end user 206 may indicate that the first end user 204 has a girlfriend in a different city than where the first end user 204 resides. The advertisement server 202 may select advertisements for roundtrip airfare between the different cities. Many examples may be presented, but they all share the commonality of selecting advertisements that are specifically targeted to a first end user based on information provided by a second end user. In other embodiments, a plurality of advertisements may be selected, although further reference will be made to the selection of one advertisement. The selected advertisement is transferred to the user device 205 of the first end user 204. The embodiment shown in FIG. 3 would be utilized to present selected advertisements to a first end user 204 when the first end user 204 and second end user 206 engage in a computer-enabled form of communication. Once the users begin a session of computer-enabled communication, the advertisement server 202 would transfer the selected advertisements to the first user device 205. The advertisements would then be presented to the first end user 204.

Turning to FIG. 4, the flow of information and data relating to selection and presentation of advertisements is depicted according to an alternative embodiment of the invention. The second end user 206 inputs information describing the first end user 204 in the second user device 207. The information describing the first user is transferred to the advertisement server 202, and the advertisement server 202 selects an advertisement based on the information provided by the second end user 206. The selection is performed based on the information provided by the second end user 204. The process strives to select advertisements that would be of special interest to the first end user 204. The information provided by the second end user 206 includes characteristics describing the first end user 204 in enough detail as to permit the advertisement server 202 to select a targeted advertisement for the first end user 204. In other embodiments, a plurality of advertisements may be selected, although further reference will be made to the selection of one advertisement. This advertisement is then transferred back to the second user device 207 for caching. The advertisement is then transferred to the first user device 205 when the first end user 204 and second end user 206 engage in a computer-enabled form of communication. Computer-enabled forms of communication include, but are not limited to: electronic mail, voice telephone communication, real time network based messaging between the first and second end user (hereinafter referred to as “instant messaging”), or any other form of communication between the first and second user that is implemented through the use of any type of computing device. The advertisement is then output by the first user device 205 to the first end user 204. The advertisement is outputted to the first end user 204 through any combination of video or audio display methods. In other embodiments of the invention, a plurality of advertisements may be selected by the advertisement server 202 for presentation to the first end user 204.

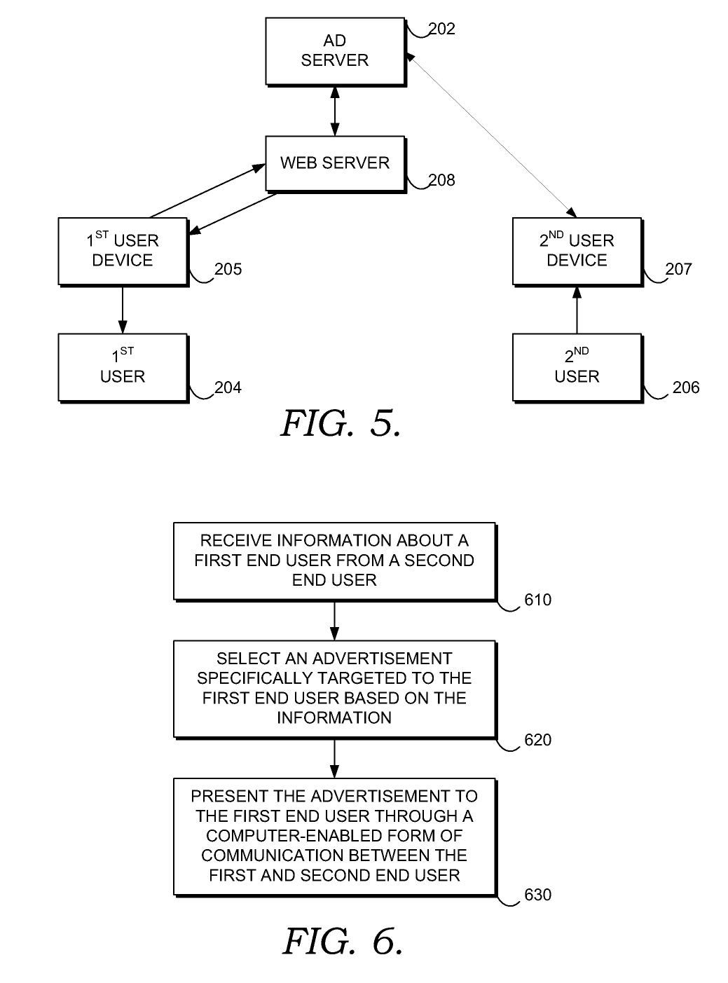

Turning to FIG. 5, the flow of information and data relating to selection and presentation of advertisements is depicted according to another embodiment of the present invention. The second end user 206 inputs information describing the first end user 204 in the second user device 207. This information is transferred to an advertisement server 202. The advertisement server 202 then selects an advertisement based on the information provided by the second end user 206. The selection is performed based on the information provided by the second end user 204. The process strives to select advertisements that would be of special interest to the first end user 204. The information provided by the second end user 206 includes characteristics describing the first end user 204 in enough detail as to permit the advertisement server 202 to select a targeted advertisement for the first end user 204. In other embodiments, a plurality of advertisements may be selected, although further reference will be made to the selection of one advertisement. The first end user 204 then requests content by interfacing with the first user device 205. The first user device 205 interprets the first end user's 204 request for content and transmits the request to the web server 208. The web server 208 processes this request and in conjunction therewith retrieves an advertisement from the advertisement server for the first end user 204 based on the information provided by the second end user 206. The advertisement is transferred to the first user device 205. The advertisement is then output by the first user device 205 to the first end user 204. The advertisement is outputted to the first end user 204 through any combination of video or audio display methods. In other embodiments of the invention, a plurality of advertisements may be selected by the advertisement server 202 for presentation to the first end user 204.

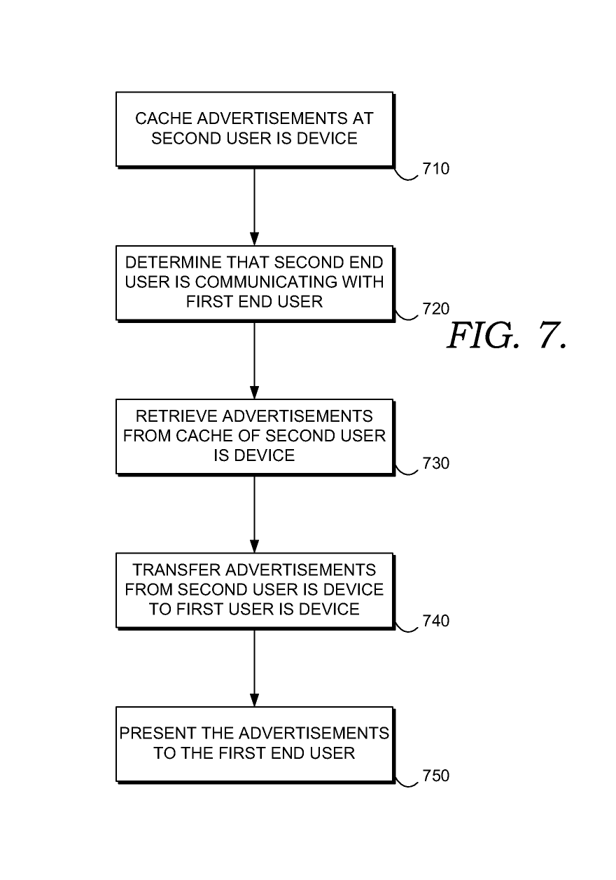

With reference now to FIG. 6, a flow diagram is provided illustrating a method of selecting and presenting targeted advertisements in accordance with one embodiment of the present invention. In block 610, information is received about a first end user, such as the first end user 204 of FIG. 2, from a second end user, such as the second end user 206 of FIG. 2. This information will typically be ultimately received at an advertisement server, such as the advertisement server 202 of FIG. 2. While generally biographical in nature, the information may describe the first user by way of: activities, hobbies, interests, relationship status, educational background, affiliation with the second user, or any other information that would permit the advertisement server to select an advertisement specifically targeted to the first end user. Illustrative examples of this information include an interest in model airplanes, a romantic relationship with a significant other that resides in a city different than that of the first end user, or an interest of the first end user in traveling to Russia.

In one embodiment of the invention, the information provided by the second end user describing the first end user is disassociated from the name of the first end user. This could be accomplished through the assignment of a unique identification number to the information provided by the second end user. In yet other embodiments, the first end user could be referred to by a username or handle. Common to all of these embodiments, is a method to mask the true identity of the first end user from the advertisement server or the web server. This may assuage privacy concerns on the part of the first end user and the second user that may arise by the providing of the information to the advertisement server or web server.

Continuing with FIG. 6, in block 620, an advertisement is selected that is specifically targeted to the first end user. The selection is performed based on the information provided by the second end user. The process strives to select advertisements that would be of special interest to the first end user. For instance, if the information supplied by the second end user indicates that the first end user builds model airplanes as a hobby, the advertisement server may select advertisements for model airplanes to present to the first end user. If the information provided by the second end user indicated that the first end user was not married, the advertisement server may select advertisements for dating services to present to the first end user. In another example, the information provided by the second end user may indicate that the first end user has a girlfriend in a different city than where the first end user resides. The advertisement server may select advertisements for roundtrip airfare between the different cities. Many examples may be presented, but they all share the commonality of selecting advertisements that are specifically targeted to a first end user based on information provided by a second end user. In other embodiments, a plurality of advertisements may be selected in block 620, although further reference will be made to the selection of one advertisement in block 620.

In block 630, the advertisement selected in block 620 is presented to the first end user through a computer-enabled form of communication between the first end user and the second end user. Computer-enabled forms of communication include, but are not limited to: electronic mail, voice telephone communication, social networking websites, real time network based messaging between the first and second end user (hereinafter referred to as “instant messaging”), or any other form of communication between the first and second user that is implemented through the use of any type of computing device.

The presentation of the advertisement to the first end user may occur before, during, or after the computer-enabled communication between the first end user and the second end user in various embodiments of the invention. For instance, in the above-cited example of the first end user having a hobby of building model airplanes, advertisements for model airplanes may be presented to the first end user while the first end user and the second end user are engaged in an instant messaging session. The advertisement could be displayed to first end user in a part of the window of the instant messaging application. In another embodiment, an audio recording of an advertisement for model airplanes could be played on the first user device. In other embodiments, the advertisement could be displayed immediately before the first end user and the second end user begin their instant messaging session. This could be accomplished by displaying the advertisement to the first end user for a set period of time before initiating the instant messaging conversation with the second end user. This could be a very brief period of time, such as while the instant messaging program loads on the first user device, such as the first user device 205 of FIG. 2, and a connection is established with the second user device, such as the second user device 207 of FIG. 2. This embodiment would have the advantage of providing a lesser intrusion into the computer enabled form of communication, because the advertisement would only be presented for a short period of time at the beginning of the session. In other embodiments, the advertisement could be displayed on the tail end of the session in similar fashion.

Turning now to FIG. 7, a flow diagram is provided illustrating a method of presenting selected advertisements to a first end user in accordance with an embodiment of the present invention. As in FIG. 6, information is first provided to an advertisement server by a second end user describing the characteristics of a first end user. The advertisement server then selects an advertisement specifically targeted to the first end user. The selection is performed based on the information provided by the second end user. The process strives to select advertisements that would be of special interest to the first end user. The information provided by the second end user 206 includes characteristics describing the first end user 204 in enough detail as to permit the advertisement server 202 to select a targeted advertisement for the first end user 204.

After an advertisement is selected based on information provided by a second end user, the advertisement is transferred from the advertisement server to the second user device for caching in block 710. The advertisements may be stored or cached in any form of computer readable media at the second user device. The transfer of advertisements between the advertisement server and the second user device may occur as a background computing process when the second user device is an otherwise idle state, so as not to interfere in the second end user's use of the second user device. In other embodiments, the transfer of a plurality of advertisements to the second user device from the advertisement server may be limited to a set number of advertisements per period of time, or an allocated percentage of the available bandwidth between the advertisement server and the second user device.

In block 720, a determination is made that the second end user is initiating a communication or communicating with the first end user. This determination may be accomplished through the recognition of a request from the first end user to engage in a computer-enabled form of communication with second end user. In one embodiment of the present invention, the determination would occur automatically, without intervention on the part of the first end user or the second end user. In alternative embodiments, the determination would be performed at the initiation of a command by the second end user to the second user device indicating that communication had been established with the first end user. During block 730, advertisements specifically targeted to the first end user are retrieved from the cache of the second user device.

In block 740, the advertisements are then transferred from the second user device to the first user device. This transfer may be accomplished through the network 201 depicted in FIG. 2. In embodiments, the advertisements may be transferred from the second user device to the first user device through a variety of computer-enabled forms of communication. Computer-enabled forms of communication include, but are not limited to: electronic mail, voice telephone communication, real time network based messaging between the first and second end user (hereinafter referred to as “instant messaging”), or any other form of communication between the first and second user that is implemented through the use of any type of computing device. As noted above, this embodiments differs from others presented in that the selected advertisement is transferred from the advertisement server to the second user device for caching or storage. The advertisement is then transferred from the second user device to the first user device, in a method similar to that of peer to peer networks. After being transferred to the first user device, the advertisements are then presented to the first end user in step 750.

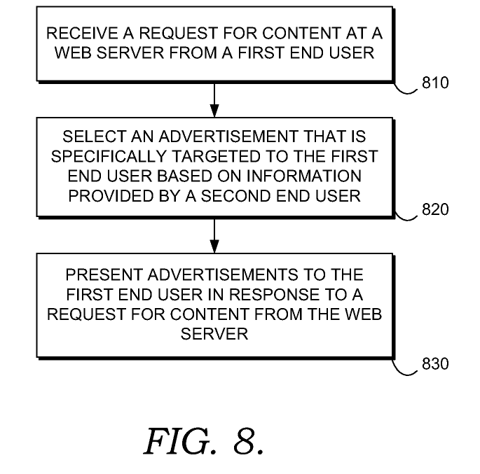

With reference now to FIG. 8, a flow diagram is provided showing a method of selecting a targeted advertisement in response to a request for content at a web server according to embodiments of the present invention. In block 810, a request is received for content at a web server 208 from a first end user 204. In one embodiment, the web server 208 may be a server for serving web pages for a social networking website. Social networking websites are generally recognized by those skilled in the art to be online social networks where people create profiles describing their hobbies, interests, and activities. The goal of social networking websites is to connect people through a network of trusted friends. Examples of social networking websites include FACEBOOK, MYSPACE, and FRIENDSTER, to name a few.

The request for content from the first end user is effectuated through a communication initiated by the first end user on the first user device and transmitted from the first user device to the web server. FIG. 5 depicts this transfer of information and requests between the components of the system. Turning back to the request for content of block 810, the requested content may include the profile of a second end user or other content associated with the second end user. The profile of the second end user would be created by the second end user and would describe in some embodiments the hobbies, activities, relationship status, or other interests of the second end user.

In block 820, an advertisement is selected that is specifically targeted to the first end user based on information provided by a second end user. The information provided by a second end user may be similar to the information described in reference to step above, although alternative embodiments may utilize information not specifically iterated above. The information could be provided to the web server by the second end user through a creation of a profile describing the first end user. This profile would differ from conventional profiles created by the first end user describing their own interests. Instead, the profile would be created by the second end user and provide information about the first end user. This information would be similar in nature to that provided in block 610 above. The method of selecting the advertisement specifically targeted to the first end user is similar to the method described in block 620 above, except that after advertisements are selected they may be cached at the web server.

Advertisements are presented to the first end user in response to the request for content from the web server. The advertisements could be presented in conjunction with the content requested by the first end user. The advertisement could be displayed to the first end user before the requested content is displayed. This could be in the form of an advertisement in the form of what is known in the art as a “pop up” advertisement. In another embodiment, the advertisement could be displayed after the first end user is finished viewing or utilizing the requested content. In other embodiments, the selected advertisement could be displayed in conjunction with the requested content. This presentation could take the form of a “banner advertisement” as known in the art. In this form the selected advertisement would be presented at the same time as the requested content and be integrated into the requested content, such that the first end user would be assured to view the selected advertisement. One skilled in the art will recognize that other forms of integration of advertisements into requested content are available and suitable for this application. By way of example, the selected advertisement could be displayed for a set period of time before the first end user is permitted to view the requested content.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A method for selecting targeted advertisements, the method comprising:
receiving information at an advertisement server about a first end user, the information provided by a second end user; and
selecting at least one advertisement that is specifically targeted to the first end user based on the information received from the second end user.

2. The method of claim 1, wherein the information received about the first end user comprises at least one of the following: activities, hobbies, interests, relationship status, educational background, and affiliation with the second end user.

3. The method of claim 1, wherein the method further comprises:
communicating the at least one advertisement for presentation to the first end user.

4. The method of claim 3, wherein the at least one advertisement is presented to the first end user through a social networking website.

5. The method of claim 3, wherein the at least one advertisement is presented to the first end user through real time network based messaging between the first and second end user, electronic mail, or voice telephone communication.

6. The method of claim 1, wherein the information provided to the advertisement server about the first end user by the second end user does not reveal the true identity of the first end user.

7. The method of claim 1, wherein the at least one advertisement is communicated to the second end user device and cached on the second user device.

8. The method of claim 3, wherein communicating the at least one advertisement for presentation to the first end user occurs while the first and second end user are engaged in a computer-enabled form of communication.

9. One or more computer storage media having computer-executable instructions embodied thereon for performing a method, the method comprising:
providing information to an advertisement server about a first end user, the information provided by a second end user, wherein the advertisement server selects at least one advertisement for presentation to the first end user that is specifically targeted to the first end user; and
communicating with a first user device associated with the first end user, wherein the at least one advertisement is communicated for presentation at the first user device

10. The one or more computer storage media of claim 9, wherein the information received about a first end user comprises at least one of the following: activities, hobbies, interests, relationship status, educational background, and affiliation with the second end user.

11. The one or more computer storage media of claim 9, wherein the at least one advertisement is presented to the first end user through real time network based messaging between the first and second end user, voice telephone communication, or electronic mail.

12. The one or more computer storage media of claim 9, wherein the method further comprises:
receiving the at least one advertisement from the advertisement server; and
caching the at least one advertisement on the second user device.

13. The one or more computer storage media of claim 12, wherein the method further comprises:
receiving a communication from the first user device, wherein the communication indicates that the first user is attempting to communicate with the second end user.

14. The one or more computer storage media of claim 13, wherein the method further comprises:
initiating a communication session between the first user device and the second user device.

15. The one or more computer storage media of claim 14, wherein the method further comprises:
communicating the at least one advertisement to the first user device, wherein the at least one advertisement is communicated to the first user device during communication between the first user and second user device, wherein the at least one advertisement is presented to the first end user.

16. The one or more computer storage media of 15, wherein the at least one advertisement is presented to the first end user occurs while the first and second end users are engaged in a computer-enabled form of communication.

17. One or more computer storage media having computer-executable instructions embodied thereon for performing a method for presenting targeted advertisements to an end user, the method comprising:
receiving a request from a first end user for content at a server for a website;
providing at least one advertisement specifically targeted to the first end user, wherein the at least one advertisement targeted to the first end user is based on information provided by a second end user; and
communicating the at least one advertisement to the first end user in conjunction with the content.

18. The computer storage media of claim 17, wherein the website is an online social network or other similar network where users create a profile, wherein the profile is viewable by other users.

19. The computer storage media of claim 18, wherein the at least one advertisement is communicated to the first end user when the first end user views a profile created by the second end user.
